(19) United States
(12) Patent Application Publication
(10) Pub. No.: US 2007/0133205 A1
(43) Pub. Date: Jun. 14, 2007

(54) DEAD WIRE HOUSING ASSEMBLY

(75) Inventor: Chung-wai (Paul) Cheng, Mid-Levels (HK)

Correspondence Address: TROUTMAN SANDERS LLP, 600 PEACHTREE STREET , NE, ATLANTA, GA, 30308, US

(73) Assignee: Cindex Holdings Limited (a Hong Kong corporation), Kowloon Bay (HK)

(21) Appl. No.: 11/610,367

(22) Filed: Dec. 13, 2006

Related U.S. Application Data
(60) Provisional application No. 60/749,817, filed on Dec. 13, 2005.

(51) Int. Cl. F21S 13/14

(52) U.S. Cl. 362/252

(57) ABSTRACT

A dead wire housing assembly for use in a light string system, wherein the dead wire housing assembly is positioned adjacent to a socket of a lamp system of the light string system. The light string system includes a plurality of lamp systems connected in series, wherein each lamp system has a light assembly and a socket assembly. The light assembly includes a light source, and a base in communication with the light source. The socket assembly includes a socket adapted to receive the base of the light assembly. The dead wire housing assembly is positioned adjacent to the socket assembly, on at least two lamp systems of the light string system. The dead wire housing assembly is adapted to house a termination of the dead wire.

### CROSS REFERENCE TO RELATED APPLICATION

This application claims benefit, under 35 U.S.C. § 119(e), of U.S. Provisional Application Ser. No. 60/749,817, filed 13 Dec. 2005, the entire contents and substance of which are hereby incorporated by reference.

### BACKGROUND OF THE INVENTION

1. Field of the Invention

The present invention relates to a housing and, more particularly, to a dead wire housing positioned adjacent to a socket of a lamp system of a light string system.

2. Description of Related Art

Light strings are generally well known in the art and are predominantly used during the holiday season for decorative purposes. Popular light strings include Christmas tree lights, outdoor holiday lights, as well as icicles light sets.

In some instances, light strings are enhanced with at least one wire that is not intended to carry current, that is a non-conducting wire. Such a “dead” wire is included, for example, for overall tensile strength, aesthetic qualities, and/or to meet safety requirements, like the Underwriters Laboratories® (“UL”) product compliance. Typically, the dead wire presents the same outward appearance as does the active or conventional wire. Yet, instead of including a conductive core, such as copper, aluminum, and the like, the dead wire includes a non-conductive core, such as cotton, rubber, polyester, and the like.

A problem with the conventional dead wire assembly is with its termination points, or ends. Typically, the termination points of the dead wire are only tied around the existing active wires. These ties are commonly located adjacent to the first and last light socket of the light string. To some consumers, the exposed tie appears shoddy and unfinished. To other consumers, it appears as if the light string is incomplete or has a wire missing, and, thus, may be considered defective.

Therefore, it can be seen that a need exists for an improved dead wire construction to allay such consumer responses. It is the provision of such a housing to house a dead wire associated with a light string system that the invention is primarily directed.

### BRIEF SUMMARY OF THE INVENTION

Briefly described, in preferred form, the present invention is a dead wire housing assembly for use in a light string system, wherein the dead wire housing assembly is positioned adjacent to a socket of a lamp system of the light string system.

The light string system upon which the present invention is located comprises a plurality of lamp systems, preferably connected electrically in series, wherein each lamp system has a light assembly and a socket assembly. The light assembly comprises a light source, and a base in communication with the light source. The socket assembly comprises a socket adapted to receive the light assembly. The lamp system further includes a dead wire housing assembly, adjacent to the socket assembly, on at least two light sources of the light string.

These and other objects, features and advantages of the present invention will become more apparent upon reading the following specification in conjunction with the accompanying drawings.

### BRIEF DESCRIPTION OF THE DRAWINGS

FIG. 1 depicts a perspective view of a lamp system, in accordance with a preferred embodiment of the present invention.

FIG. 2 depicts a perspective, partial cross-sectional view of a socket assembly and a dead wire housing assembly, in accordance with a preferred embodiment of the present invention.

FIG. 3 depicts a cross-sectional view of the dead wire housing assembly without a dead wire therein, in accordance with a preferred embodiment of the present invention.

FIG. 4 depicts a cross-sectional view of the dead wire housing assembly including a dead wire therein, in accordance with a preferred embodiment of the present invention.

FIG. 5 depicts a top view of the dead wire housing assembly without a dead wire, in accordance with a preferred embodiment of the present invention.

FIG. 6 depicts a side view of the lamp system fully assembled, in accordance with a preferred embodiment of the present invention.

FIG. 7 depicts a cross-sectional view of a dead wire assembly, in accordance with an embodiment of the present invention.

### DETAILED DESCRIPTION OF THE PREFERRED EMBODIMENTS

To facilitate an understanding of the principles and features of the invention, it is explained hereinafter with reference to its implementation in an illustrative embodiment.

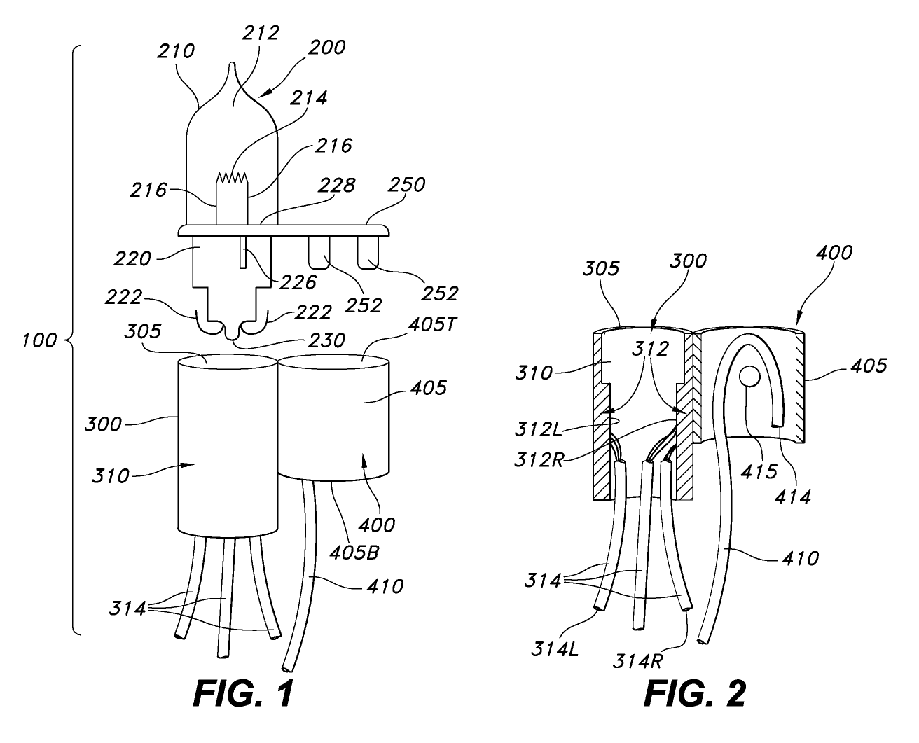

Referring now in detail to the figures, FIG. 1 is a perspective view of a preferred embodiment of a lamp system 100 in a light string system 10 (FIG. 8). A light string system 10 using the present invention can comprise a plurality of lamp systems 100 connected electrically in series, wherein each lamp system 100 has a light assembly 200 and a socket assembly 300, and at least two lamp systems 100 include a dead wire housing assembly 400.

The light assembly 200 comprises a light source 210, and a base 220 in communication with the light source 210. The socket assembly 300 comprises a socket 310 adapted to receive the light assembly 200. Lamp systems 100 further includes the dead wire housing assembly 400, positioned adjacent to the socket assembly 300 for housing a termination 414 of a dead wire 410.

The light assembly 200 includes the light source 210. The light source 210 is adapted to provide light or illuminate when energized. As shown in FIG. 8, the light string system 10 can be energized, preferably, by a plug P inserted into an electrical outlet. The plug P provides energy to the conductive wires 314, which can provide energy to each lamp system 100.

Referring back to FIG. 1, one skilled in the art can appreciate that the light source 210 can be many types of light sources, including a light bulb, light emitting diode (LED), incandescent lamp, halogen lamp, fluorescent lamp, and the like. Preferably, the light source 210 is a light bulb. The light assembly 200, and more typically, the light source 210 of the light assembly 200 can include a shunt device (not shown) to keep the light string system illuminated, even if the light source 210 burns out.

The light source 210 can include a globe 212 and a filament 214. The globe 212 is in communication with, and terminates at, the base 220. The globe 212 can be made of conventional translucent or transparent material such as plastic, glass, and the like. Typically, the globe 212 defines a hollow interior enabling protection of the filament 214.

The filament 214, when charged with energy, illuminates the light source 210. Conductors 216 can be in electrical communication with the filament 214. The conductors 216 enable energy into the light source 210 to illuminate the filament 214, and thus the light source 210. The conductors 216 extend down through the base 220, wherein preferably the conductors 216 can be in communication with a pair of lead wires 222 external the base 220. The lead wires 222 extend through a bottom of the base 220, and are a pair of wires wrapped around the base 220 extending upwardly in the direction of globe 212, adjacent the base 220.

The light assembly 200 further includes the base 220. The base 220 can be integrally formed with the light source 210. The base 220 can be a unitary element of the light source 210, or a separate element. Preferably, the base 220 communicates between the light source 210 and an associated socket 310, complimenting and facilitating the seating of the light assembly 200 to the socket 310. The base 220 can incorporate a least one ridge 226 to ensure a snug fit with the socket 310, preventing the accidental disengagement of the light assembly 200 from the socket assembly 300. Other mechanical means, including a latch or locking system, can be used with the base 220 and the socket assembly 300 to ensure a tight fit. Additionally, the base 220 can further include a flange 228 to seal the base 220 of the light source 210 into the socket 310. The termination point of the base 220 is referred to a base end 230 and extends downward from the base 220.

The socket assembly 300, which is illustrated in a cross-sectional view in FIG. 2, comprises the socket 310 adapted to receive the light assembly 200. The socket 310 defines a cooperatively-shaped aperture 305 to receive the base 220 of the light assembly 200. In a preferred embodiment, the socket 310 is also adapted to receive the base 220, in its entirety. The socket 310 can be arranged in many shapes and sizes, but as one skilled in the art will recognize, the socket 310 should be of a shape to conveniently receive the light assembly 200.

The socket 310 includes a pair of socket terminals 312. The socket terminals 312 are, preferably, located on opposing inner sides of the socket 310. The socket 310 further includes at least a pair of terminal wires 314 extending to the exterior to allow energy to enter (and exit) the socket 310. FIGS. 1-2 depict three terminal wires 314 extending to/from the socket 310; these preferably illustrate the first and last socket 310 of the light string. The remaining sockets 310 can have two wires 314 (see, for instance, FIG. 8); this typically includes all the sockets 310 in the light string system 10, save the first and last socket 310 of the string.

Each socket terminal 312 is, essentially, an extension of each respective terminal wire 314. The terminal wire 314 extends through the bottom of the socket 310 and is ultimately connected to an electrical source. Therefore, the electrical current is introduced into the socket 310 by one of the terminal wires 314 and conducted either through socket terminal 312 or through lead wires 222 to the filament 214 to illuminate the light source 210. Regardless of path, the current will flow to the other of the lamp systems 100 of the light string.

For example, as shown in FIG. 2, the socket 310 incorporates the socket terminal 312, such that an electric circuit is provided from the left terminal wire 314L, through the left socket terminal 312L across through the light source 210, and ultimately to the right terminal wire 314R via the right socket terminal 312R.

Light string systems 10 are typically arranged with lamp systems 100 on the strings being electrically connected in series, rather than in a parallel arrangement. Unfortunately, there are disadvantages to designing a light string in series. When even a single light assembly 200 is removed from a socket 310, the entire series of lights is rendered inoperable. Because each light assembly 200 within its respective socket 310 completes the electrical circuit, when a light assembly 200 is removed or the filament 214 of the light source 210 burns out, a gap is created in the circuit; that is, an open circuit is formed. Thus, electricity is unable to continue to flow through the circuit.

To overcome this dilemma, the socket assembly 200 can include a shunting device to enable the energy flowing through the light string system 10 to continue to flow even when a light assembly 200 is absent from the socket 310. For instance, the light source 210 of the light assembly 200 will remain illuminated even though there may exist: an open filament, for example, a dead bulb, faulty or damaged bulb, faulty socket, or simply because the bulb is not properly mounted in its respective socket, or is entirely removed or falls out of its respective socket. For instance, the bypass activating system described in Massabki et al., U.S. Ser. No. 11/473,504, filed Jun. 23, 2006, the entire disclosure of which is incorporated herein by reference, can be used as the shunting device.

Positioned adjacent to the socket assembly 300 is a dead wire housing assembly 400. The dead wire housing assembly 400 is adapted to house an end of a dead wire 410 from the light string system 10. The dead wire housing assembly 400 can include a dead wire cap 250, a housing 405 and a rod 415. FIGS. 2-4 illustrate cross-sectional views of the socket assembly 300 and the dead wire housing assembly 400.

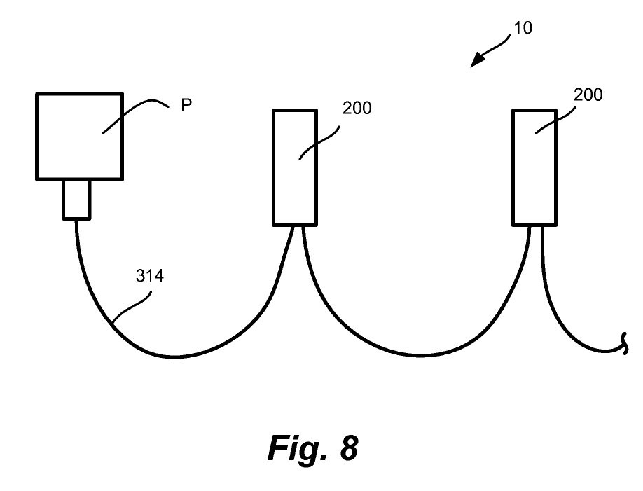

The dead wire 410 can be used in the light string system 10. The dead wire 410—alternatively known as a non-wire, non-conducting, or pseudo wire—lacks a conductive core 412 (FIG. 7) that exists in typical wires, for example, the wire 314. Such a dead wire construction (without a conductive core) can save money over using a live wire construction (with a conductive core) in a dead wire fashion, for example, as providing tensile strength to the string, providing aesthetic qualities, and/or to meet safety requirements.

The dead wire 410 is preferably in outward appearance the same as an active wire, for example, the wire 314. The difference between the conventional, active wire 314 and the dead wire 410 is that the latter is not used to conduct electricity, and indeed preferably lacks an electrically conductive core 412. In exemplary embodiments, the dead wire 410 includes a central non-conductive core of cotton, polyester, plastic, rubber, nylon and the like, which contribute to the tensile strength of the dead wire 410. The dead wire 410 can also be a solid piece of rubber, similar to an outer layer of an electrical conductive core.

Referring back to FIG. 1, the dead wire cap 250 can be attached to the flange 228 of the base 220 of the light source 210. The dead wire cap 250 can extend laterally from the base 220. The dead wire cap 250 can, in alternative embodiments, be separate structure from the flange 228 of the base 220. The dead wire cap 250 can have at least one extending member 252. The extending member 252 can help seal and secure the dead wire 410 in the dead wire housing 405. For example, the extending member 252 can extend downward, and thus be in parallel arrangement with the base 220 of the light source 210. In a preferred embodiment, there are two extending members 252 that can secure the wire 410 between them when the cap 250 is seated in the housing 405.

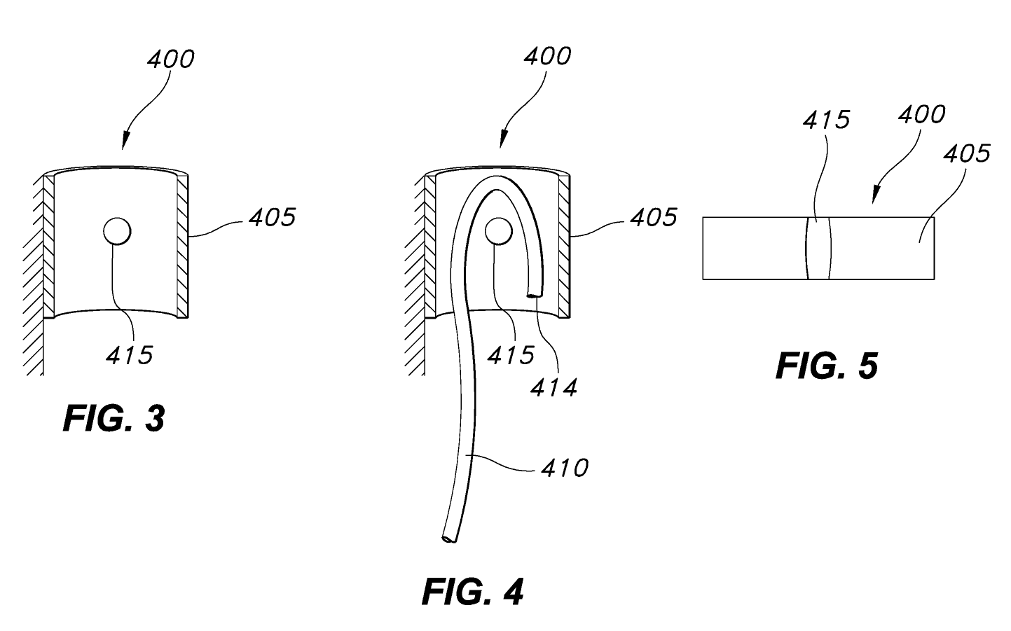

FIGS. 3-5 show that the housing 405 enables a termination 414, or an end, of the dead wire 410 to be hidden from view within the housing 405. The housing 405 can be many shapes, such as cylindrical, square, rectangle, triangular, circular, and the like. In a preferred embodiment, the housing 405 of the dead wire housing assembly 400 is cylindrical, because this shape can be designed large enough to hide the termination 414 of dead wire 410.

The housing 405 preferably includes a top, a bottom, and sides. In one embodiment, as shown in FIG. 1, the top 405T is devoid of material to receive the cap, and the bottom 405B is also devoid of material so as to receive the dead wire 410. In another embodiment, the top and bottom 405T and B is not devoid of material, and includes a majority of a top and bottom surface, with apertures there through, for acceptance of the extending member(s) 252 and/or the wire 410. In such an embodiment, the housing 405 is more sealed from the elements than if the top and bottom of the assembly 400 is completely open.

The housing 405 of the dead wire housing assembly 400 can include a fulcrum, for example, a rod or brace 415. The rod 415 can be of a substantially cylindrically shaped design. As illustrated in FIG. 5, the rod 415, in a preferred embodiment, can extend from one internal side wall of the housing 405 to the opposing internal side wall of the housing 405. The rod 415 provides the necessary stability to wrap the dead wire 410 over in the housing 405. In an alternative embodiment, the rod 415 can span a substantial distance from one opposing wall to another. One skilled in the art will recognize that the length of the rod 415 is dependent upon the weight and length of the dead wire 410.

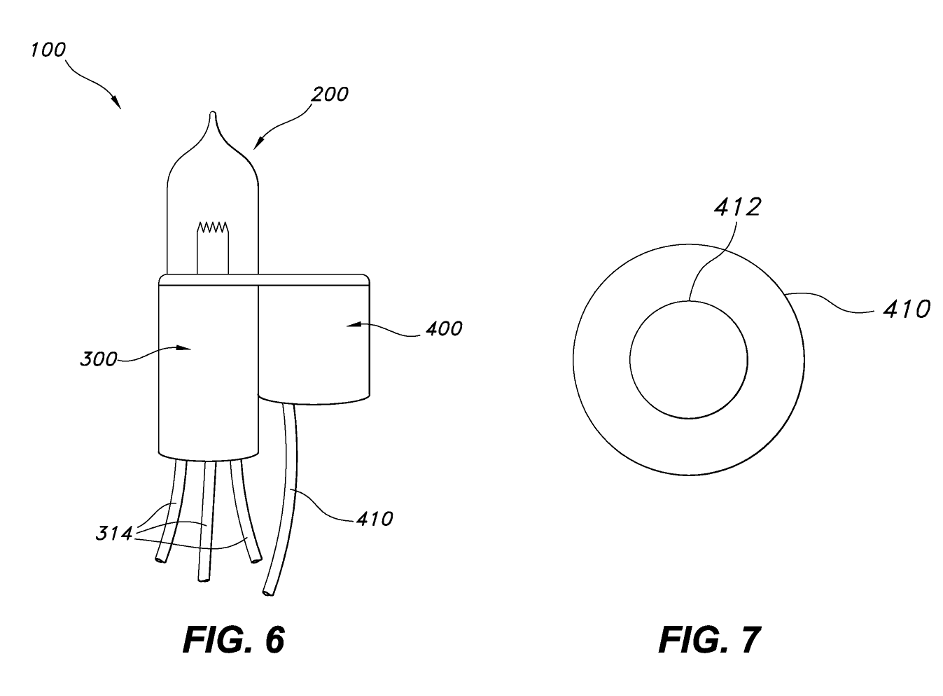

FIG. 6 is a perspective of a first or last lamp assembly 100 in the lights string system with the dead wire housing assembly 400 positioned adjacent to the socket assembly 300. The light assembly 200 is housed in the socket assembly 300, and the termination 414 of the dead wire 410 is housed in the dead wire housing assembly 400.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. In a light string system including a plurality of lamp systems, at least two conductive wires connecting the lamp systems to one another for providing energy, and a non-conductive wire, wherein each lamp system has a light assembly with a light source adapted to illuminate and a base in communication with the light source, and wherein each lamp system has a socket assembly having a socket for receiving and housing the base of the light assembly,
the improvement comprising a housing of at least one lamp system being adapted to securedly receive an end of the non-conductive wire, and hide it from view.

2. The improvement of claim 1, wherein the non-conductive wire comprises a first end and a second end, and wherein a first housing receives the first end of the non-conductive wire and a second housing receives the second end of the non-conductive wire.

3. The improvement of claim 1, wherein the housing is positioned adjacent with the socket.

4. The improvement of claim 1, wherein the housing is coupled to the socket.

5. The improvement of claim 1, wherein the housing is in communication with a first lamp system, electrically closest to an electrical plug, and a last lamp system, electrically farthest from the electrical plug, in the plurality of lamp systems.

6. The improvement of claim 1, wherein the housing defines a cavity having a fulcrum therein extending from an internal side wall, and wherein the non-conductive wire is adapted to wrap about the fulcrum for secured reception of the non-conductive wire in the housing.

7. The improvement of claim 1, wherein the housing has a cylindrical shape, and wherein a top of the housing and a bottom of the housing are open.

8. The improvement of claim 1, wherein the top of the housing is adapted to cooperatively receive a cap extending outwardly from a flange between the light source and the base of the light assembly, the cap sealing the top of the housing upon insertion in the housing.

9. The improvement of claim 1, wherein the non-conductive wire is twisted about one of the conductive wires for increasing the tensile strength of the light string system.

10. The improvement of claim 1, wherein the non-conductive wire comprises a non-conductive core.

11. A dead wire housing assembly comprising:
a lamp system including a light assembly and a socket assembly;
a conductive wire to provide energy to the lamp system from an energy source;
a non-conductive wire; and
a housing carried by the socket assembly for shielding from view an end of the non-conductive wire.

12. The dead wire housing assembly of claim 11, wherein the light assembly comprises a light source adapted to illuminate and a base in communication with the light source, and wherein the socket assembly comprises a socket for receiving and housing the base of the light assembly.

13. The dead wire housing assembly of claim 11, wherein the housing comprises a cylindrical shape having a top and a bottom, the housing receiving the non-conductive wire from the bottom.

14. The dead wire housing assembly of claim 13, wherein the housing includes a fulcrum therein for securing the non-conductive wire within the housing about the fulcrum.

15. The dead wire housing assembly of claim 14, wherein the housing includes a releasably securable cap for the top of the housing.

16. A lamp system comprising:
a light assembly including:
a light source adapted to illuminate; and
a base in communication with the light source;
a socket assembly including a socket, the socket adapted to receive the base of the light assembly;
a conductive element to provide energy to the lamp system from an energy source;
a dead wire; and
a dead wire housing assembly including a housing for protecting an end of the dead wire.
